(19) United States
(12) Patent Application Publication
(10) Pub. No.: US 2009/0043000 A1
(43) Pub. Date: Feb. 12, 2009

(54) COMPOSITION FOR PREPARING A DEGRADABLE POLYOL POLYESTER, PROCESS FOR OBTAINING A POLYOL POLYESTER, AN ELASTOMER, FOAMS, PAINTS AND ADHESIVES, AND A DEGRADABLE POLYOL POLYESTER FOAM

(75) Inventors: Jefter Fernandes Nascimento, Sao Paulo city (BR); Wagner Mauricio Pachekoski, Sao Carlos (BR); Jose Ricardo De Lello Vicino, Sao Carlos (BR)

Correspondence Address: DARBY & DARBY P.C., P.O. BOX 770, Church Street Station, New York, NY, 10008-0770, US

(73) Assignee: PHB INDUSTRIAL S.A., Serrana - SP (BR)

(21) Appl. No.: 12/162,156

(22) PCT Filed: Feb. 23, 2007
(86) PCT No.: PCT/BR2007/000046

§ 371 Date: Sep. 15, 2008

(30) Foreign Application Priority Data
Feb. 24, 2006 (BR) PI0600782-1

(51) Int. Cl. C08J 9/35; C08G 63/06

(52) U.S. Cl. 521/95; 528/361

(57) ABSTRACT

The present invention refers to a composition of mixtures based on poly(hydroxybutyrate) polymer and vegetable oils, with the object of preparing a degradable polyol polyester. In the process, the poly(hydroxybutyrate) plus the vegetable oil react under heating, producing the polyol polyester, which once purified can be utilized in applications similar to those of the traditional polyurethane: adhesives, foams, elastomers and paints.

### FIELD OF THE INVENTION

The present invention refers to a composition based on a biodegradable polymer defined by polyhydroxybutyrate or copolymers thereof and comprising at least one vegetable oil, one isocyanate and at least one additive, such as: a catalyst, a surfactant, a pigmentation agent, a filler or an expanding agent, with the object of preparing a degradable polyol polyester.

According to the production process, the biodegradable polymer and the vegetable oil react under heating, producing the polyol polyester which, once purified, can be utilized in applications similar to those of the traditional polyurethane, such as adhesives, foams, elastomers and paints.

### PRIOR ART

It is known from the prior art different composite materials in the form of biodegradable polyurethane foams comprising a biodegradable filling material which is mixed with a polyol and an isocyanate to form a polyurethane foam. It is also known the addition of different additives to said mixture so as to improve its production and/or its properties.

Polymeric compound is any composition of one or more polymers with modifying additives, these being in an expressive quantity.

There are several patents which describe the obtention of polyurethanes/polyesters from the poly(hydroxybutyrate), such as for example, patent document U.S. Pat. No. 4,324,880 that describes the transesterification reaction of PHB for the production of polyurethanes with trimethylolpropane or penthaeritritol, both reagents coming from not renewable sources and of high cost. U.S. Pat. No. 5,352,763 also mentions the formation of oligomers obtained from poly(hydroxybutyrate) with polyester isocyanates. U.S. Pat. No. 5,665,831 discloses esterification conditions of the PHB with ethyleneglycol using conditions similar to those of U.S. Pat. No. 4,324,880 and U.S. Pat. No. 5,665,831. However, as described in patent WO 02/06368 A2, the patents obtained by the processes described above do not present biodegradability or possibility of recycling, and present low flexibility and hydrofobicity.

The present invention relates to the utilization of products obtained from natural and renewable sources in the esterification of PHB for obtaining polyols, which, within our knowledge, has not been described or utilized yet. Biodegradable products (foams, adhesives, paints and elastomers) were obtained which, according to the proportion of their reagents, vary their main properties in a wide range, resulting in products or higher or lower flexibility, density and hydrofobicity. Thus, the products based on these compositions can reach a wide spectrum of utilization in the most different fields.

### SUMMARY OF THE INVENTION

It is a generic object of the present invention to provide a degradable polyol polyester to be utilized in different applications, such as adhesives, foams, elastomers and paints, by using a biodegradable polymer defined by polyhydroxybutyrate or copolymers thereof and vegetable oils, allowing obtaining degradable polyurethanes to substitute the traditional polyurethanes.

According to a first aspect of the invention, it is provided a composition for preparing polyol polyester comprising a biodegradable polymer defined by poly(hydroxybutyrate) or copolymers thereof; at least one vegetable oil; one isocyanate; and at least one additive presenting one of the functions of: catalyst, surfactant, pigmentation, filler and expansion.

According to a second aspect of the invention, it is provided a process for obtaining polyol polyester as defined above and that comprises the steps of:

a) heating the composition under atmosphere of nitrogen until a PHB melting temperature lying from about 140 to about 180° C., permitting the reaction to continue spontaneously with increase of the temperature to values from 180 to 220° C.; and
b) cooling the product of the reaction, maintaining the temperature controlled at about 170° C. during about 10-20 minutes, to obtain a dark liquid product with the temperature being maintained until about 175° C., and a brown solid product when the temperatures are maintained upper than about 200° C.

The polyol polyester obtained as defined above can also be submitted to a purifying step by multiple washings in water to separate the impurities.

### DETAILED DESCRIPTION OF THE INVENTION

### Materials:

Poly(3-hydroxybutyric acid)-PHB:

Within the class of the biodegradable polymers, the structures containing ester functional groups are of great interest, mainly due to their usual biodegradability and versatility in physical, chemical and biological properties. Produced by a large variety of microorganisms, as a source of energy and carbon, the polyalkanoates (polyesters derived from carboxylic acids) can be synthesized either by biological fermentation or chemically.

The poly(hydroxybutyrate)-PHB is the main member of the class of the polyalkanoates. Its great importance is justified by the combination of 3 important factors: it is 100% biodegradable, it is water-resistant and it is a thermoplastic polymer, enabling the same applications as the conventional thermoplastic polymers. Formula 1 below shows the structural formula of the (a) 3-hydroxybutyric acid and (b) Poly(3-hydroxybutyric acid)-PHB.

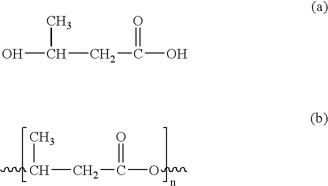

The production process of the polyhydroxybutyrate basically consists of two steps:
Fermentative step: in which the microorganisms metabolize the sugar available in the medium and accumulate the PHB in the interior of the cell as source of reserve.
Extractive step: in which the polymer accumulated in the interior of the microorganism cell is extracted and purified until a solid and dry product is obtained.

The project developed by PHB Industrial S.A. allowed to use sugar and/or molasse as a basic component of the fermentative medium, fusel oil (organic solvent—byproduct of the alcohol manufacture) as extraction system of the polymer synthesized by the microorganisms, and also the use of the excess sugarcane bagasse to produce energy (vapor generation) for these processes. This design permitted a perfect vertical integration with the maximum utilization of the byproducts generated in the sugar and alcohol manufacture, providing processes that utilize the so-called clean and ecologically correct technologies.

Through a production process similar to that of the PHB, it is possible to produce a semicrystalline bacterial copolymer of poly-(3-hydroxybutyrate) with random segments of poly-(3-hydroxyvalerate), known as PHBV. The main difference between both processes is based on the addition of proprionic acid in the fermentative medium. The quantity of proprionic acid in the bacteria feeding is responsible for the control of hydroxyvalerate-PHV concentration in the copolymer, enabling to vary the degradation time (which can be from some weeks to several years) and certain physical properties (molar mass, crystallinity degree, surface area, for example). The composition of the copolymer further influences the melting point (which can range from 120 to 180° C.), and the characteristics of ductility and flexibility (which are improved with the increase of HV concentration). Formula 2 shows the basic structure of the PHBV.

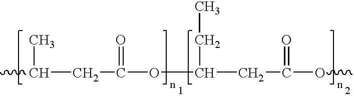

According to some studies, the PHB shows a ductile behavior with a maximum elongation of 40%, tension elastic modulus of 1.4 GPa and notched IZOD impact strength of 90 J/m soon after the injection of the specimens. Such properties modify with time and stabilize in about one month, with the elongation reducing from 40% to 10% after 15 days of storage, reflecting the fragilization of the material. The tension elastic modulus increases from 1.4 GPa to 3.5 GPa, while the notched Izod impact strength reduces from 90 J/m to 25 J/m after the same period of storage. This phenomenon, known as “aging”, is attributed to secondary crystallizations and confinement of the amorphous regions, to be discussed ahead. Table 1 presents some properties of the PHB compared to the Isostatic Polypropylene.

TABLE 1
Comparison of properties of PHB and PP.

| | PHB | PP |
|---|---|---|
| % degree of crystallinity | 80 | 70 |
| Average molar mass (g/mol) | 4 × 105 | 2 × 105 |
| Melting temperature (° C.) | 175 | 176 |
| Glass transition temp. (° C.) | −5 | −10 |
| Density (g/cm³) | 1.2 | 0.905 |
| Modulus of flexibility (GPa) | 1.4-3.5 | 1.7 |
| Tensile strength (MPa) | 15-40 | 38 |
| % of Elongation at break | 4-10 | 400 |
| UV Resistance | good | poor |
| Solvent Resistance | poor | good |

The degradation rates of the articles made of PHB or its Poly(3-hydroxybutyric-co-hydroxyvaleric acid)-PHBV copolymers, under several environmental conditions, are of great relevance for the user of these articles. The reason that makes them acceptable as potential biodegradable substitutes for the synthetic polymers is their complete biodegradability in aerobic and anaerobic environments to produce CO₂/H₂O/biomass and CO₂/H₂O/CH₄/biomass, respectively, through natural biological mineralization. This biodegradation usually occurs via surface attack by bacteria, fungi and algae. The actual degradation time of the biodegradable polymers and, therefore, of the PHB and PHBV, will depend upon the surrounding environment, as well as upon the thickness of the articles.

### Vegetable Oils

The vegetable oils or fats are fatty substances, greasy when touched, of triglyceridic nature or not, which are present in cellular organels of oleaginous grains or fruits, which are known as lipidic bodies or espherosome. Besides the utilization as a food product, the vegetable oils are used in pharmaceutical, chemical, cosmetic industries, as oils or as raw material for obtaining chemical compounds of interest. The latter is the wide field of the oil chemical industry (see table below). Moreover, since 1932, it is already known that the vegetable oil can be utilized in engines as a fuel. In the beginning of the decade of 1980, with the increase of the petroleum prices, a discussion started about the viability of finding a renewable substitute for the Diesel. The palm oil (Elaeis guineensiswas) the culture contemplated to provide the raw material, due to the high yield of oil per planting area, as can be evidenced through the data below. Nowadays, the program has been reformulated, but all the oleaginous articles are considered as potential sources.

An important raw material to be used in the present invention is the castor oil, a mixture which contains about 90% of triglyceride of the ricinoleic acid. Besides being found practically pure in nature, it is still a rare source of hydroxylade and insaturate fatty acid. Its composition and idealized structure are respectively shown in FIG. 3 and Table 2. Due to its composition and privileged structure, it can suffer several chemical reactions, being possible to obtain a great variety of products.

The vegetable oils can be used “in natura” form (as found in nature), or one of their derivatives coming from soybean, corn, castor-oil plant, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and their possible hydrogenated derivatives, being present in the composition in a mass proportion lying from about 10% to about 90%, preferably from about 30% to about 70%.

Table 2 shows the standard properties of the castor oil.

TABLE 2
Composition of the castor oil

| Component | Quantity |
|---|---|
| Ricinoleic acid | 89.5% |
| Dihydroxystearic acid | 0.7% |
| Palmitic acid | 1% |
| Estearic acid | 1% |
| Oleic acid | 3% |
| Linoleic acid | 4.2% |
| Linolenic acid | 0.3% |

TABLE 3
Standard Properties of the castor oil

| Property | Value |
|---|---|
| Acidity Index (mg/KOH/g) - max | 2.0 |
| Gardner Color- max | 2.0 |
| Hydroxyl Index(mg/KOH/g) | 160-170 |
| Heat loss (% max.) | 0.2 |
| Index of Refraction, 25° C. | 1.4764-1.4778 |
| Saponification Index | 176-178 |
| Iodine Index | 84-88 |
| Solubility in alcohol (ethanol) | Complete |
| Density, 25° C. | 0.957-0.961 |
| Viscosity cm2/s (Stokes) | 6.5-8 |
| Ignition Temperature, ° C. | 449 |
| Surface Stress (dyn/cm), 20° C. | 39 |

Idealized structure of the castor oil.

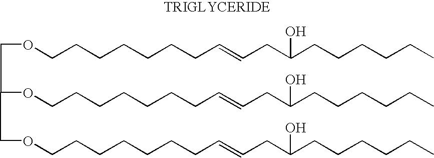

### Isocyanates

The isocyanates are used in the reaction with the Polyols and additives, forming the biodegradable polyurethane foams, as described. The result obtained is an expansion process resulting from the reaction of the polyols with polyisocyanates, and comprises at least 2 isocyanate functional groups. The generic reaction of this process is described in Formula 4, whereas the generic bond for this process is described in Formula 5.

The polyisocyanates, which can be used for obtaining the foams described, comprise aromatic, aliphatic, cycloaliphatic compounds, combinations thereof, as well as those obtained from trimerization with water. 1-methyl-benzene 2,4-diisocyanate, 1-methylbenzene 2,6-diisocyanate, 1,1-methylene bis(4-isocyanate benzene), 1-isocyanate-2(4-isocyanate phenyl)benzene, naphthalene 1,5 diisocyanate, 1,1′,1″-methylenetris (benzene 4 isocyanate), p-phenylenediisocyanate, and mixtures thereof can be used.

The aliphatic polyisocyanates comprise the 1,6-diisocyanate, and the cycloaliphatic polyisocyanates comprise the 1,3,3′-trimethyl cyclohexane-5-isocyanate-1-(methylisocyanate), toluene diisocyanate and mixtures thereof, being present in the composition in a mass proportion lying from about 20% to about 60%, preferably from about 35% to about 55%.

Due to the production facility and reduced costs, the more useful diisocyanates for obtaining the foams described in the present solution are 1-methyl-benzene 2,4-diisocyanate and toluene diisocyanate, whose idealized structures are showed in Formula 6.

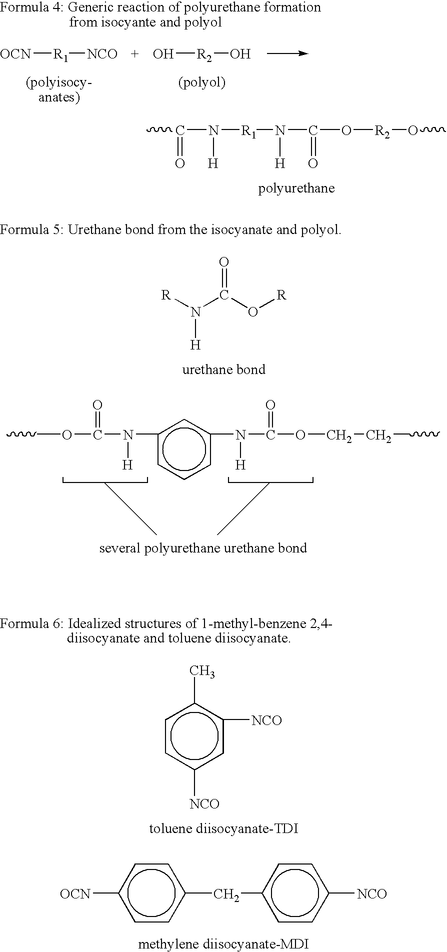

### Additives

Additives are compounds added in small quantities that promote alterations and improvements in the obtained foams. Catalysts, surfactants, pigments, fillers, expanding agents, flame retardants, antioxidants, radiation protectors, are preferably used, individually or in mixtures.

The added catalysts based on terciary amines comprises triethylenediamine, pentamethyldiethylenetriamine, N-ethylmorphiline, N-methylmorphiline, tetramethylethylenediamine, dimethylbenzylamine, 1-methyl-4-dimethylamine ethyl piperazine, N,N-diethyl 3-diethylamine propylamine, 1-(2-hydroxypropyl)imidazole; other types of useful catalysts can be of the organotin, organoferric, organomercury and organolead type, as well as inorganic salts of alkaline metals.

The catalysts for this reaction can be acids or strong bases. As examples of strong bases, we can mention potassium hydroxide and sodium hydroxide, of inorganic acids the sulphuric and chloridric acids and of organic acid the para-toluene sulphonic acid. The catalyst used herein is a base of an alkaline or alkaline terrous metal, p-toluene sulphonic acid or acids coming from elements contained in the families 4A, 5A, 6A and 7A.

As alternative for catalysts, organometallic compounds in the same proportion that the acid and basic catalysts can be used. Of this class, the product P6131 produced by Logos Química can be particularly used. The use of this product has as advantages: to allow the synthesis to be carried out in lower temperatures, as well as to ensure the integrity of the PHB structure during the reaction, reducing the occurrence of secondary reactions and the degradation of the poly(hydroxybutyrate).

The catalysts are present in the composition in a mass proportion lying from about 0.5% to about 3%, preferably from about 1% to about 2%.

The surfactants comprise organic surfactants, preferably fatty acids and organo-silane used individually or in mixtures. Preferably, the fatty acids comprise salts of the sulphonated ricinoleic acid, organo, whereas silanes comprise poly(dimethylsiloxane) and poly(phenylmethylsiloxane), individually or in mixtures, being present in the composition in a mass proportion lying from about 0.5% to about 3%, preferably from about 1% to about 2%.

The pigments comprise metallic oxides and carbon black, individually or in mixtures, such as azo compounds, phthalocyanines and dioxazines, present in the composition in a mass proportion lying from about 0.5% to about 3%, preferably from about 1% to about 2%.

The fillers comprise particles and fibers, individually or in mixtures, mainly carbonates, alumine and silica, individually or in mixtures, as well as natural and synthetic fibers, present in the composition in a mass proportion lying from about 0.5% to about 3%, preferably from about 1% to about 2%.

Several expanding agents can be used for obtaining the described foams. Apart from the chlorofluorocarbons, used for a long time as expanding agents, including the difluorochloromethane, difluoroethane, the tetrafluoroethane, described in U.S. Pat. No. 4,945,119, environmental pressures forced the production of new expanding agents less aggressive to the ozone layer, such as for example, the aliphatic and cycloaliphatic components: n-penthane, i-penthane, cyclopenthane or mixtures thereof, as described in Brazilian patent. PI 9509500-4.

However, for preparing the foams described in the present invention, the expanding agent can be defined only by water, which reacts with the polyisocyanate forming carbon dioxide.

### Methodology for Producing the Polyols Polyesters

### Pre-Mixture:

A pre-mixture of poly(hydroxybutyrate) or its copolymer is carried out with the vegetable oil in a mixer of the “Henschel” type in the proportions determined in the present invention over a period of 5 minutes or until complete homogeneity.

### Addition of the Catalyst

The catalyst is added in the proportion ranging from about 1:100-1:200. The “Henschel” mixer is used to promote the complete incorporation of the catalyst.

### Reaction

The mixture is heated under atmosphere of nitrogen until a melting temperature of the PHB (depending on the product, this temperature can range from 140 to 180° C.). From this point, the reaction occurs spontaneously, with increase of temperature to values from 180 to 220° C. The cooling system is activated, maintaining the temperature controlled at about 170° C. during about 10-20 minutes. The product obtained is a dark liquid, provided that the temperature does not exceed 175° C. For temperatures higher than 200° C. in identical reaction conditions, the product obtained is a brown solid.

### Purification

After the mixture has cooled to the ambient temperature, the purification process of the obtained product is started through three washing steps with water to separate the impurities. After the washing, the material is vacuum dried.

### Determination of the Properties

Several properties of the obtained product were determined, aiming at establishing parameters for utilizing the product as raw material of polyurethanes, among them: structural characterization through Fourier Transform Infrared Spectroscopy (FTIR), molar mass, acidity index, hydroxyl index, density.

Polymerization with Isocyanates

The products obtained were polymerized with isocyanates for obtaining articles ranging from foams to elastomers, paints and adhesives. Several types of additives, depending on the final application, can also be used.

For obtaining elastomers there were added anti-bubble additives in the proportion (mass/mass) from 1-1.5% and organometallic catalysts in the proportion (mass/mass) from 0.2-0.7%. After complete homogenization, the isocyanate is added and mixed. The mixture remains under vacuum during 30 minutes for removal of the bubbles.

Rigid foams were obtained through the reaction of the polyol-polyester with an isocyanate. Once mixed, the product was additivated with organometallic catalysts, aminics, silicone surfactants and expanding agents. Once all the components are added, the expansion is carried out under a mixing operation in foam injectors, or with the aid of a manual mixer (hand mix).

### Description of the Formulations and Properties of the Compounds

### Formulations for Obtaining the Polyol Polyester:

### EXAMPLE 1

Tests of mixtures with 9.9% of poly(hydroxybutyrate), 89.1% of castor oil and 1% of NaOH catalyst, in a reaction temperature of 170° C. during 10 minutes, obtaining a liquid as final product.

### EXAMPLE 2

Tests of mixtures with 19.80% of poly(hydroxybutyrate), 79.2% of castor oil and 1% of NaOH catalyst, in a reaction temperature of 170° C. during 20 minutes, obtaining a liquid as final product.

### EXAMPLE 3

Tests of mixtures with 39.6% of poly(hydroxybutyrate), 59.4% of castor oil and 1% of NaOH catalyst, in a reaction temperature of 170° C. during 20 minutes, obtaining a liquid as final product.

### EXAMPLE 4

Tests of mixtures with 59.4% of poly(hydroxybutyrate), 39.6% of castor oil and 1% of NaOH catalyst, in a reaction temperature of 170° C. during 10 minutes, obtaining a liquid as final product.

### EXAMPLE 5

Tests of mixtures with 49.5% of poly(hydroxybutyrate), 49.5% of castor oil and 1% of NaOH catalyst, in a reaction temperature of 170° C. during 10 minutes, obtaining a liquid as final product.

### EXAMPLE 6

Tests of mixtures with 49.5% of poly(hydroxybutyrate), 49.5% of castor oil and 1% of NaOH catalyst, in a reaction temperature of 200° C. during 15 minutes, obtaining a solid as final product.

### Formulation for Obtaining Elastomers

### EXAMPLE 7

Tests of mixtures with 82.3% of polyol polyester (as in examples 1 to 6 of item 4.1), 0.4% of tin octoate catalyst, 0.8% of anti-bubble additive, 16.5% of diisocyanate (1-methyl-benzene 2,4-diisocyanate).

### EXAMPLE 8

Tests of mixtures with 76% of polyol polyester (as in examples 1 to 6 of item 4.1), 0.4% of tin octoate catalyst, 0.8% of anti-bubble additive, 22.8% of diisocyanate (1-methyl-benzene 2,4-diisocyanate).

### EXAMPLE 9

Tests of mixtures with 70% of polyol polyester (as in examples 1 to 6 of item 4.1), 0.3% of tin octoate catalyst, 0.7% of anti-bubble additive, 29% of purified diisocyanate (1-methyl-benzene 2,4-diisocyanate).

### EXAMPLE 10

Tests of mixtures with 76% of polyol polyester (as in examples 7 of item 4.1), 0.4% of tin octoate catalyst, 0.8% of anti-bubble additive, 22.8% of diisocyanate (1-methyl-benzene 2,4-diisocyanate).

### EXAMPLE 11

Tests of mixtures with 70% of polyol polyester (as in examples 1 to 6 of item 4.1), 0.3% of tin octoate catalyst, 0.7% of anti-bubble additive, 29% of polymeric diisocyanate (1-methyl-benzene 2,4-diisocyanate).

### Formulation for Obtaining Foams

### EXAMPLE 12

Tests of mixtures with 64.6% polyol polyester (as in examples 1 to 6 of item 4.1), 0.2% of tin octoate catalyst, 0.2% of tetramethylethylenediamine, 0.6% of surfactant poly(dimethylsiloxane), 32.3% of diisocyanate (1-methyl-benzene 2,4-diisocyanate), 2.1% of water as expanding agent.

### EXAMPLE 13

Tests of mixtures with 74.2% of polyol polyester (as in examples 1 to 6 of 4.1), 0.25% of tin octoate catalyst, 0.25% of tetramethylethylenediamine, 0.74% of surfactant poly(dimethylsiloxane), 22.3% de diisocyanate (1-methyl-benzene 2,4-diisocyanate), 2.26% of water as expanding agent.

### EXAMPLE 14

Tests of mixtures with 60.7% of polyol polyester (as in examples 1 to 6 of item 4.1), 0.21% of tin octoate catalyst, 0.21% of tetramethylethylenediamine, 0.6% of surfactant poly(dimethylsiloxane), 36.42% of diisocyanate (1-methyl-benzene 2,4-diisocyanate), 1.86% of water as expanding agent.

### EXAMPLE 15

Tests of mixtures with 64.6% of polyol polyester (as in examples 1 to 6 of item 4.1), 0.2% of tin octoate catalyst, 0.2% of tetramethylethylenediamine, 0.6% of surfactant poly(dimethylsiloxane), 32.3% of polymeric diisocyanate (1-methyl-benzene 2,4-diisocyanate), 2.1% of water as expanding agent.

### EXAMPLE 16

Tests of mixtures with 57.2% of polyol polyester (as in examples 1 to 6 of item 4.1), 0.2% of tin octoate catalyst, 0.2% of tetramethylethylenediamine, 0.57% of surfactant poly(dimethylsiloxane), 40% of polymeric diisocyanate (1-methyl-benzene 2,4-diisocyanate), 1.83% of water as expanding agent.

### PROPERTIES OF THE EXAMPLES

Due to their intrinsic properties of degradation, the applications in which this characteristic is desirable are those of great importance, mainly in “one way” products, such as packages and specific agricultural areas. The most adequate applications are package dunnages, packages for electro-electronic products, disposable food packages, agriculture trays for the growing of plant seedlings and hydropony, and plant seedling recipients for reforestation.

The elastomers are mainly used as byproducts, such as degradable adhesives and paints.

| | OBTAINED MATERIAL | | |
|---|---|---|---|
| | Polyol | | |
| PROPERTY | polyester | Elastomer | Foam |
| Density (g/cm³) | 0.9-1.2 | 1.0-1.2 | 18-40 |
| Shore Hardness A | — | 40-90 | — |
| Shore Hardness 00 | — | — | 25-60 |
| Elongation at Break | — | 150-400 | — |
| (MPa) | | | |
| Breaking Stress | — | 5-10 | — |
| (MPa) | | | |
| Hydroxyl Index | 45-120 | — | — |
| (mg KOH/mg sample) | | | |
| Acidity Index | 0.7-2.5 | — | — |
| (mg KOH/mg sample) | | | |

### Essays of Biodegradation

Pulverized samples of the products cited in the invention had their biodegradability evaluated in biologically active soil over a period of 120 days. It was observed that, in this period of time, these samples were totally consumed, characterizing the biodegradability of the material.

1. Process for obtaining polyol polyester, wherein it comprises the steps of:
a) proving an homogeneous mixture of biodegradable polymer defined by poly (hydroxybutyrate) or its copolymers with at least one vegetable oil;
b) heating the mixture under atmosphere of nitrogen until a melting temperature of the poly (hydroxybutyrate) lying from about 140 to about 180° C., permitting the reaction of the polymer with vegetable oils to continue spontaneously with increase of the temperature to values from 180 to 220° C. in order to obtain the polyol polyester;
c) cooling the product of the reaction, maintaining the temperature controlled at about 170° C. during about 10-20 minutes, in order to obtain a dark liquid product when the temperature is maintained up to about 175° C., and a brown solid product when the temperature is maintained upper than about 200° C.;
d) cooling the product of the reaction until ambient temperature;
e) purifying the product of the reaction; and
e) drying the purified product.

2. Process, as set forth in claim 1 wherein the mixture further comprises an additive of the catalyst type in a mass proportion lying from about 0.5% to about 3%.

3. Process, as set forth in claim 2 wherein the additive of the catalyst type is selected from triethylenediamine, pentamethyldiethylenetriamine, N-ethylmorphiline, N-methylmorphiline, tetramethylethylenediamine, dimethylbenzylamine, 1-methyl-4-dimethylamine ethyl piperazine, N,N-diethyl 3-diethylamine propylamine, 1-(2-hydroxypropyl)imidazole or other types of organotin, organoferric, organomercury and organolead catalysts, as well as inorganic salts of alkaline metals.

4. Process, as set forth in claim 3 wherein the catalyst is a base of an alkaline or alkaline terrous metal, p-toluene sulphonic acid or acids coming from elements contained in the families 4A, 5A, 6A and 7A.

5. Process, as set forth in claim 1, wherein the biodegradable polymer is provided in the mixture in a mass proportion lying from about 10% to about 90% the vegetable oil being present in the mixture, in a mass proportion lying from about 10% to about 90%.

6. Process, as set forth in claim 5 wherein the vegetable oil is “in natura” (as found in nature) or a derivative coming from soybean, corn, castor-oil plant, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuau, poppy and their possible hydrogenated derivatives.

7. Process, as set forth in claim 1 wherein the purifying step is carried out through washing steps with water to separate the impurities.

8. Process, as set forth in claim 1 wherein the drying step is carried out under vacuum.

9. A polyol polyester, obtained by the process as defined in claim 1, wherein it is used as a lubricant, as a protecting and encapsulating product for seeds in the agricultural area, and as agricultural defensives and nutrients.

10. Process for obtaining an elastomer from the polyol polyester, defined in claim 1, wherein it comprises the steps of:
mixing the polyol polyester with anti-bubble additives in the mass proportion lying from about 1% to about 1.5% and with organometallic catalyst additives, in the mass proportion lying from about 0.2% to about 0.7%;
homogenizing and mixing the mixture of polyol polyester and additives with isocyanate for polymerization; and
maintaining the mixture under vacuum for the removal of the bubbles.

11. Process, as set forth in claim 10, wherein the polymerizing mixture is maintained under vacuum for about 30 minutes.

12. Process, as set forth in claim 10, wherein the isocyanate is selected from:
1-methyl-benzene 2,4-diisocyanate, 1-methylbenzene 2,6-diisocyanate, 1,1-methylene bis (4-isocyanate benzene), 1-isocyanate-2(4-isocyanate phenyl)benzene, naphthalene 1,5 diisocyanate, 1,1′,1″-methylenetris 25 (benzene 4 isocyanate), p-phenylenediisocyanate, 1,6 diisocyanate, 1,3,3′-trimethyl cyclohexane-5-isocyanate-1-(methylisocyanate), toluene diisocyanate and mixtures thereof.

13. Process, as set forth in claim 10, wherein the isocyanate being present in the mixture in a mass proportion lying from about 20% to about 60%.

14. Process for obtaining foams through the polyol polyester defined in claim 1, wherein it comprises the reaction of the polyol polyester with an isocyanate under mixture and additivation with organometallic catalysts, aminics, silicone surfactants and expanding agents, the expansion being carried out under a mixing operation in foam injectors, or with the aid of a manual mixer (hand mix).

15. Degradable polyol polyester foam, obtained by the process defined in claim 14, and wherein it comprises a mixture of polyol polyester, isocyanate and organometallic catalysts, aminics, silicone surfactants and expanding agents, wherein it is used in package dunnages, packages for electro-electronic products, disposable food packages, agricultural trays for the growing of plant seedlings and hydropony, and plant seedling recipients for reforestation.

16. Process, as set forth in claim 1 wherein the mixture further comprises an additive of the catalyst type in a mass proportion lying from about 1% to about 2%.

17. Process, as set forth in claim 1, wherein the biodegradable polymer is provided in the mixture in a mass proportion lying from 30% to about 70%, and the vegetable oil being present in the mixture, in a mass proportion lying from about 30% to about 70%.

18. Process, as set forth in claim 10, wherein the isocyanate being present in the mixture in a mass proportion lying from about 35% to about 55%.
